(19) United States
(12) Patent Application Publication
(10) Pub. No.: US 2007/0204006 A1
(43) Pub. Date: Aug. 30, 2007

(54) METHODS AND SYSTEMS FOR DISTRIBUTING MOVIES FOR OWNERSHIP

(76) Inventor: Charles Vallis, Lynnfield, MA (US)

Correspondence Address: ANTOINETTE G. GIUGLIANO, P.C., 100 Cummings Center, Suite 342G, Beverly, MA, 01915, US

(21) Appl. No.: 11/678,380

(22) Filed: Feb. 23, 2007

Related U.S. Application Data
(60) Provisional application No. 60/776,721, filed on Feb. 24, 2006.

(51) Int. Cl. G06F 15/16

(52) U.S. Cl. 709/217

(57) ABSTRACT

The present invention relates to methods for obtaining one or more copies of a movie or media via the internet using a computer having a hard drive and a digital media device. A movie or media is made up of a set of digital files. The methods include downloading the set of movie or media digital files that have been purchased or authorized for use by the user to the hard drive, wherein the set of files is stored on the hard drive for a length of time necessary to transfer said files to a recordable medium in the digital media device; transferring the set files to the recordable medium in the digital media device; and automatically deleting the set of files from the hard drive without input from the user. The method preventing other non-authorized users from file sharing or copying the files.

### RELATED APPLICATION

This application claims the benefit of U.S. Provisional Application No. 60/776,721, entitled “Methods and Systems for Distributing Movies for Ownership,” by Charles Vallis, filed Feb. 24, 2006.

The entire teachings of the above application are incorporated herein by reference.

### BACKGROUND OF THE INVENTION

Movie studios generally do not sell or license movies over the internet because of the fear of file sharing and unauthorized copying of movies. File sharing has caused problems and significant monetary loss to the record industry. Several websites exist that offer music to be purchased by digital downloading but the files may be stored and easily shared or redistributed. Although the files have basic copy protection, in many instances such protection has not deterred file sharing. File sharing and unauthorized copying of music files often negatively impacts the pricing of an authorized downloaded music file, and the movie industry would prefer to prevent the same from occurring.

Accordingly, a need exists for methods and systems that allow for authorized distribution of movies over the internet. A further need exists for methods and systems that allow distribution of movies over the internet while preventing unauthorized or illegal distribution of the files, as seen in the music industry.

### SUMMARY OF THE INVENTION

The present invention relates to methods for obtaining one or more copies of a movie or media via the internet using a computer having a hard drive and a digital media device, wherein the movie or media comprises a set of digital files. The steps of the methods include downloading to the hard drive the set of digital movie or media files that have been purchased or authorized for use by the user, wherein the set of files is stored on the hard drive for a length of time necessary to transfer the files to a recordable medium (e.g., DVD) in the digital media device. The method further includes transferring the set files to the recordable medium in the digital media device; and automatically deleting, erasing, rendering unusable, or any combination thereof, the set of files from the hard drive without input from the user. All or a portion of the files can be downloaded, transferred and deleted. When a portion of the files undergo the process, the steps can be repeated more then one time until all of the movie files undergo the process (e.g. downloaded, transferred and deleted from the original hard drive). Such steps prevent other non-authorized users from file sharing or copying files because the movie files do not remain on the hard drive of the computer. Examples of digital media devices that can be used with the methods of the present invention include DVD burners, devices having an external hard drive including a Digital Video Recorder (DVR) devices (e.g., TiVo, or ReplayTV), or a portable digital media playing device such as an Ipod. The user can purchase the movie, or be authorized to download the movie or media with a license that is purchased. The length of time that the set of movie or media files is stored on the hard drive ranges from about 1 minute to about 1 hour before being deleted.

The present invention further pertains to methods for distributing a copy of a movie or media via the internet using a computer having a hard drive and a digital media device, wherein the movie or media comprises a set of digital files or a (e.g., one or more) container file having digital files. The methods include performing the steps of purchasing said movie or media or obtaining authorization (e.g., via a license) to copy said movie or media; and selecting the digital media device to which the set of movie or media files is to be copied. The user interacts with a graphical user interface (GUI) to provide instructions to the web application. In particular, the user chooses what movie and features is to be downloaded, how to pay for the movie, choose the digital media device to be used, etc. In an embodiment, once the user's choices are made, the downloading, burning and automatic deletion of the movie files occur in one step, without further input required from the user.

Once selected, the method automatically downloads the set of movie or media files that have been purchased by the user to the hard drive, wherein the set of files is stored for a length of time necessary to transfer the files to a recordable medium in the digital media device; transfers the set of files to the recordable medium in the digital media device; and deletes the set of files from the hard drive. As described above, the all or a portion of the files can undergo the method at a time, and as such, the steps of the method can be repeated one or more times. Such a method prevents non-authorized use of the files including prevention of file sharing or copying movie files.

The present invention encompasses systems for obtaining one or more copies of a movie or media (e.g., a set of digital files) via the internet. The system includes a computer having a hard drive and a digital media device; a recordable medium; and software that performs the steps described herein. In particular, the software, when executed, downloads the set of movie or media digital files that have been purchased or authorized for use by the user to the hard drive, wherein the set of files is stored on the hard drive for a length of time necessary to transfer said files to a recordable medium in the digital media device; transfers the set of files to the recordable medium in the digital media device; and automatically deleting, erasing, rendering unusable, or any combination thereof, the set of files from the hard drive without input from the user, as described herein.

The present invention has several advantages. The methods of the present invention benefits the movie industry by lowering distribution costs and manufacturing costs, and providing the potential for more availability and selection of movies through the ease of digital distribution. The movie industry also enjoys protection from unauthorized reproduction and distribution of movies (e.g., bootlegging) because the customer retains a hard copy of the movie that is created in the process. The consumer also advantageously benefits from the methods of the present invention because the consumer, in one click, receives a higher quality of movies associated with digital technology, as compared to streaming videos and enhanced compatibility, e.g., the ability to play movie in home theater system, car, airplane. The present invention also provides convenience and better economics of shopping from home, the ability to enhance movies by including menus and special features, and conserve hard-drive space by automatic deletion of data. The methods of the present invention make the act of shopping for movies a simple process for the user. Overall, the methods and systems of the present invention enable permanent retention of the movie by the consumer while protecting the rights of the movie industry.

### BRIEF DESCRIPTION OF THE DRAWINGS

FIG. 1 is a schematic showing the flow of media files when steps of the present invention are performed.

### DETAILED DESCRIPTION OF THE INVENTION

A description of preferred embodiments of the invention follows.

The present invention relates to methods for distributing a set of movie or media files in a digital format via the internet to an authorized user. The movie industry is often weary of distributing movies on online for fear of widespread illegal distribution. The present invention encompasses methods for distributing movies to authorized users, while discouraging file sharing or copying of files by unauthorized users.

Specifically, the methods involve the downloading of a movie which comprises a set of digital files or data. The files downloaded when carrying out the methods of the present invention can be digital video or movie files, or files that can be converted to movie files (container files or compressed files). A container file or container format is a computer file format that can contain various types of files, often compressed by means of standardized audio/video codecs. The phrase “digital files” or “movie files” includes container files or compressed files that contain one or more digital video or movie files. These files generally contain full-motion, digital video, and can be in any suitable format including, but not limited to, Audio Video Interleaved (AVI) files or a mpeg file. AVI is a windows multimedia video format that interleaves standard waveform audio and digital video frames (bitmaps) to provide reduced animation at 15 fps at 160×120×8 resolution and audio in 11,025 Hz, 8-bit samples. Files downloaded also include any features found on movie DVD, including menus, bonus features, anamorphic video, subtitles, digital rights management (DRM), etc. Data, as used herein, refers to an electronic form of information, and including database data, text, images, audio and video.

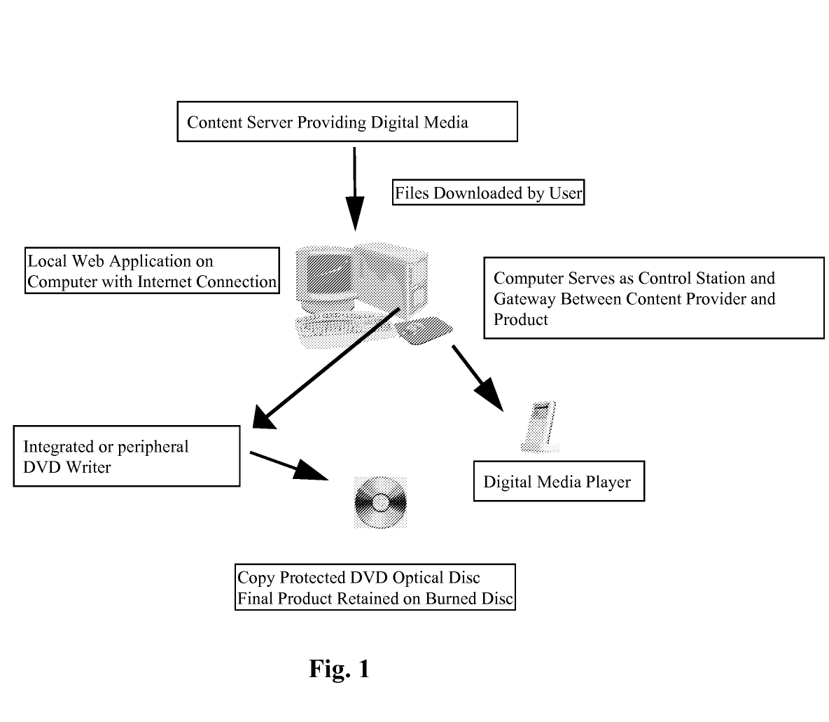

Such files or data can be distributed to an authorized user by temporarily downloading movie data from the web to the hard drive, and transferring the data to a recordable media disk or external hard drive. Referring to FIG. 1, the user downloads movie files from a content server having digital movie files and files associated therewith. The files are temporarily downloaded the hard drive, or burned directly to recordable medium. “Downloading” refers to the act of receiving a file or series of files transmitted via the internet “Temporarily downloading” movie files refers to downloading the files to the hard drive of the authorized user's computer for a length of time necessary to transfers the files to a recordable medium in a digital media device, and then automatically deleting, erasing or otherwise removing the files from the hard drive without the user's input.

The copying of such files from the hard drive to the recordable medium and the subsequent deletion can occur all at once (i.e., all movie files (100%) are downloaded to the hard drive, then all files are copied to a recordable medium, and then the files on the hard drive are deleted or erased), or can happen in increments (e.g., 5% of the files are downloaded to the hard drive, then these files are copied to the recordable medium and deleted from the hard drive; then another 5% of additional files are downloaded and then copied; the steps are repeated until 100% of the files are copied to the recordable medium). The latter method utilizes a recordable medium to which files can be recorded more than once (e.g., DVD-RW). By downloading, copying and deleting or erasing a percentage of the files at a time further prevents a possible unauthorized user from file sharing or copying the files because all the files needed to view the movie are not present at the same time on the hard drive. For this method, any percentage of the files can be downloaded, copied and deleted (e.g., ranging from about 1% to about 99% of the files).

Rather than copying to a hard drive and automatically deleting the files, in another embodiment, the present invention involves directly transferring or writing media files from the server providing the content directly to a digital media device optical disc (DVD). The present invention involves an automatic process for media retention by the consumer without storing any usable digital file on the hard drive of the personal computer.

In one embodiment, the files can be encrypted to further prevent unauthorized copying or file sharing when placed on the recordable medium or viewed by the authorized user. Optical discs or DVDs made from the steps of the present invention, in an embodiment, also contain copy protection encryption such as secure burn, content scramble system (CSS) (Qflix, Sonic Solutions, Novato, Calif.), or similar encryption. The encryption provided to a pre-recorded DVD's can be applied to the recordable medium used herein. For example, a burned DVD product can have special keys written into the lead-in area of the disc to emulate the appearance of a pre-recorded disc.

The method can be carried out using programming language known in the art, or later developed. The user interacts with a graphical user interface (GUI), or an interface known in the art, or later developed to provide user instructions, as described herein. The steps of the present invention can be implemented by any computer based web application containing any programming language such as Microsoft base C# for the .NET framework integrating components for assembling and writing DVD video to an optical disc. Other examples of software that can be used to such software include, e.g., AJAX (Asynchronous Java and XML) software, DreamWeaver, and FLASH software, javascript, php, css, asp, cold fusion, jsp ruby, ruby on rails, and the like. An interface refers to any mechanism by which an external user can provide their instructions.

File Sharing, through peer-to-peer network, exists on the internet and allows users to share files on their hard disks, essentially creating global peer-to-peer networks. By removing files from the hard drive, file sharing can be prevented.

The process, in one embodiment, includes a web-based interface that has integrated DVD authoring technology and the capability to permanently transfer data to a disc or device, using the methods further described herein.

The process can be done on any personal computer located in a home, workplace, cafes, video stores, libraries or any place where there is a personal computer.

The length of time needed to transfer the set of movie files from the hard drive to the recordable medium depends on a number of factors such as the size and number of files, encryption of files, the computer's memory and processor, and the speed at which the digital media device records onto the recordable medium. The length of time, depending on these and other factors, can typically range between about less than 1 minute and about 1 hour.

In various embodiments, methods of the present invention involve either deleting or erasing the movie files. Deleting the files refers to removing the file name from its directory, and erasing files refers to removing the data from the disk sector. In one embodiment, files are deleted so that an ordinary user would not be able to access the movie files. However in another embodiment, the files can be erased from the disk sector to prevent a more savvy, unauthorized user from accessing the files. In the case of deleting or erasing file, unusable digital files can remain on the hard drive. The definition of “deleted” or “erased” files includes files that are completely removed, files that are partially removed and rendered unusable, files that are otherwise modified or rendered unusable, or any combination thereof.

A type of personal computers can be used to carry out the present invention so long as the computer has sufficient memory, processor speed, system requirements and space on the hard drive. The computer should also have an integrated or peripheral digital media device attached to or in communication with the computer.

The digital media device is a device that allows one to store movie files, and associated files, to a recordable medium in such a way that the movie can be viewed. Any digital media device now known and developed in the future can be used so long as the device can store movie files on a recordable medium that is built in or removable. Method for recording data on an optical disc are known and described e.g., in U.S. Pat. No. 6,530,009. Digital media devices include, but are not limited to, DVD burners, Digital Video Recorders (DVRs), external hard drive devices, or portable devices or media player (e.g., an Ipod or mobile phone capable of viewing movies). Also known as a “personal video recorder” (PVR), or “hard disk recorder,” a DVR is a consumer device that digitizes broadcast or cable TV onto a hard disk using MPEG-2 compression. Examples of DVRs include products from ReplayTV (www.replaytv.com) and TiVo.

Any type of recordable medium can be used so long as one can store movie files and view the movie when the movie files are executed. Recordable mediums now known and developed in the future can be used. Examples of recordable mediums include any type of optical disk, a DVD Media disk, a DVD-Video disk, a DVD-RAM disk, a DVD-R disk, and a DVD-RW disk. A DVD Media disk is an optical digital disc for storing movies and data. DVD-Video is the movie format, which uses MPEG-2 compression to provide approximately two hours of video per side at standard definition TV resolution (480i resolution).

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for obtaining one or more copies of a movie or media via the internet using a computer having a hard drive and a digital media device, wherein the movie or media is comprised of a set of digital files or a container file having said files; the method comprises the steps of:
a. downloading the set of movie or media digital files or container file having said files that have been purchased or authorized for use by the user to the hard drive, wherein the set of files is stored on the hard drive for a length of time necessary to transfer said files to a recordable medium in the digital media device;
b. transferring the set files to the recordable medium in the digital media device; and
c. automatically deleting, erasing, rendering unusable, or any combination thereof, the set of files from the hard drive without input from the user,
thereby preventing other non-authorized users from file sharing or copying said files.

2. The method of claim 1, wherein the digital media device is a DVD burner, a device having an external hard drive, or a portable device.

3. The method of claim 2, wherein the external hard drive is part of a Digital Video Recorder (DVR) device.

4. The method of claim 2, wherein the recordable medium is a DVD.

5. The method of claim 1, wherein the user is authorized to download said movie or media with a license.

6. The method of claim 2, wherein the set of movie or media files is stored on the hard drive for a length of time ranging from about 1 minute to about 1 hour before being deleted.

7. A method for distributing a copy of a movie or media via the internet using a computer having a hard drive and a digital media device, wherein the movie or media is comprised of a set of digital files or a container file having said files; the method comprises the steps of:
a. purchasing said movie or media or obtaining authorization to copy said movie or media; and
b. selecting the digital media device to which the set of movie or media files is to be copied; wherein once said movie or media is purchased and digital media device selected, the method automatically performs the steps comprising of:
i. downloading the set of movie or media files or container file having said files that have been purchased or authorized for use by the user to the hard drive, wherein the set of files is stored for a length of time necessary to transfer said files to a recordable medium in the digital media device;
ii. transferring the set files to the recordable medium in the digital media device; and
iii. deleting, erasing, rendering unusable, or any combination thereof, the set of files from the hard drive;
thereby preventing other non-authorized users from file sharing or copying said files.

8. The method of claim 7, wherein the digital media device is a DVD burner, a device having an external hard drive, or a portable device.

9. The method of claim 8, wherein the external hard drive is part of a Digital Video Recorder (DVR) device.

10. The method of claim 8, wherein the recordable medium is a DVD.

11. The method of claim 7, wherein the user is authorized to download said movie or media with a license.

12. The method of claim 7, wherein the set of movie or media files is stored on the hard drive for a length of time ranging from about 1 minute to about 1 hour before being deleted.

13. A system for obtaining a one or more copies of a movie or media via the internet, wherein the movie or media is comprised of a set of digital files or a container file having said files, the system comprises:
a. a computer having a hard drive and a digital media device;
b. a recordable medium; and
c. software that performs the steps of:
i. downloading the set of movie or media digital files or container file having said files that have been purchased or authorized for use by the user to the hard drive, wherein the set of files is stored on the hard drive for a length of time necessary to transfer said files to a recordable medium in the digital media device;
ii. transferring the set files to the recordable medium in the digital media device; and
iii. automatically deleting, erasing, rendering unusable, or any combination thereof, the set of files from the hard drive without input from the user;
thereby preventing other non-authorized users from file sharing or copying said files.

14. The system of claim 13, wherein the digital media device is a DVD burner, a device having an external hard drive, or a portable device.

15. The system of claim 14, wherein the external hard drive is part of a Digital Video Recorder (DVR) device.

16. The system of claim 14, wherein the recordable medium is a DVD.

17. The system of claim 13, wherein the set of movie or media files is stored on the hard drive for a length of time ranging from about 1 minute to about 1 hour before being deleted.
